(19) United States
(12) Patent Application Publication
(10) Pub. No.: US 2018/0324293 A1
(43) Pub. Date: Nov. 8, 2018

(54) CALL RECORDING

(71) Applicant: BRITISH TELECOMMUNICATIONS PUBLIC LIMITED COMPANY, London (GB)

(72) Inventors: Andrew DAVIS, London (GB); Robert CLAXTON, London (GB)

(21) Appl. No.: 15/763,642

(22) PCT Filed: Sep. 29, 2016
(86) PCT No.: PCT/EP2016/073237

§ 371 Date: Mar. 27, 2018

(30) Foreign Application Priority Data
Sep. 30, 2015 (EP) 15187782.6

(51) Int. Cl. H04M 3/42; G10L 19/018; G10L 17/16; H04M 3/56; H04M 3/51

(52) U.S. Cl. CPC H04M 3/42221; G10L 19/018; G10L 17/16; H04M 2203/303; H04M 3/51; H04M 2203/301; H04M 3/568

(57) ABSTRACT

An enterprise voice system such as a contact centre is disclosed which provides a speech analytics capability. Whilst call recording is common in many contact centres, calls are normally recorded in single-channel audio files in order to save costs. Previous attempts to provide automatic diarization of those recorded calls have relied on training the system to recognise voiceprints of users of the system, and then comparing utterances within the recorded calls to those voiceprints in order to identify who was speaking at that time. In order to avoid the need to train the system to recognise voiceprints, an enterprise voice system is disclosed which inserts a digital watermark into the digitised audio signal from each user's microphone. By inserting the digital watermark with an energy, and, in some cases also with a spectrum, which matches the digitised audio signal, and taking advantage of typically only one user speaking at a time, a mark is left in the recorded call which a speech analytics system can use in order to identify who was speaking at different times in the conversation.

The present invention relates to a method of generating a single-channel audio signal representing a multi-party conversation. It has particular utility in recording conversations carried by enterprise voice systems such as teleconferencing systems, call centre systems and trading room systems.

Automatic speech analytics (SA) for contact-centre interactions can be used to understand the drivers of customer experience, assess agent performance and conformance, and to perform root-cause analysis. An important element of speech analytics is the automatic production of a transcript of a conversation which includes an indication of who said what (or the automatic production of a transcript of what a particular party to the conversation said).

US patent application US 2015/0025887 teaches that each conversation in a contact centre is recorded in a mono audio file. Recording conversations in mono audio files is a great deal cheaper than recording conversations in files having separate audio channels for different speakers. However, in subsequent analysis of the recorded conversation this brings in a need to separate the talkers in the conversation. The above patent application achieves this using a transcription process in which blind diarization (establishing which utterances were made by the same person) is followed by speaker diarization (establishing the identity of that person). The blind diarization uses clustering to identify models of the speech of each of the participants in the multi-party conversation. A hidden Markov Model is then used to establish which participant said each utterance in the recorded conversation. The speaker models are then compared with stored voiceprints to establish the identity of each of the participants in the conversation.

There is a need to provide enterprise voice systems which avoid the complexity of training the system to recognise voiceprints of all the users of those systems whilst still enabling talker separation and the use of single-channel audio recording. The use of single-channel audio recording reduces memory and bandwidth costs associated with the enterprise voice system.

According to a first aspect of the present invention, there is provided a method of generating a single-channel audio signal representing a multi-party conversation, said method comprising:

receiving a plurality of audio signals representing the voices of respective participants in the multi-party conversation, and for at least one of the participants, marking the audio signal representing the participant's voice by:

i) finding the current energy in the audio signal representing the participant's voice;

ii) generating a speaker-dependent signal having an energy proportional to the current energy in the audio signal representing the participant's voice; and

iii) adding said speaker-dependent signal to the audio signal representing the participant's voice to generate a marked audio signal;

generating a single-channel audio signal by summing said at least one marked audio signal and any of said plurality of audio signals which have not been marked.

Because, in general, only one person speaks at any one time in a multi-party conversation, and because the energy in a telephony signal will increase greatly when the telephony signal contains speech rather than background noise, by receiving a plurality of audio signals representing the voices of respective participants in the multi-party conversation, and for at least one of the participants, marking the audio signal representing the participant's voice as set out above, and thereafter generating a single-channel audio signal by summing the marked audio signal and any other audio signals which have not been marked, at points in the multi-party conversation where the at least one participant is speaking, the speaker-dependent signal for the at least one participant will contain sufficient energy in comparison to the other signals in the single-channel audio signal to render it detectable by a subsequent diarization process despite it being mixed with the audio signals representing the input of the other participant or participants to the multi-party conversation (the input from the other participant or participants often merely being background noise).

In some embodiments, said speaker-dependent signal is generated from a predetermined speaker identification signal. This simplifies generating a speaker-dependent signal with an energy which is proportional to the energy in the speaker's audio signal measured over whatever time period the added speaker-dependent signal extends over. In particular, the speaker identification signal, or a portion of the speaker identification signal added during a energy analysis time period, can be scaled by an amount proportional to the energy found in the audio signal over that energy analysis time period to generate said speaker-dependent signal.

In some embodiments, said speaker identification, speaker-dependent and audio signals comprise digital signals. This allows the use of digital signal processing techniques.

In some embodiments, the speaker identification signal comprises a digital watermark. A digital watermark has the advantage of being imperceptible to a person who listens to the marked audio signal—such as one or more of the participants to the conversation in embodiments where the marked audio signal is generated in real time, or someone who later listens to a recording of the multi-party conversation.

In some cases, the speaker identification signal is a pseudo-random bit sequence. The pseudo-random bit sequence can be derived from a maximal length code—this has the advantage of yielding an autocorrelation of +N for a shift of zero and −1 for all other integer shifts for a maximal length code of length N; shifted versions of a maximal length code may therefore be used to define a set of uncorrelated pseudo-random codes.

Some embodiments further comprise finding the spectral shape of the audio signal over a spectral analysis time period, and then spectrally shaping the speaker-identification signal, or a portion thereof, to generate a speaker-dependent signal whose spectrum is similar to the spectrum of the audio signal representing the at least one participant's voice. This allows a speaker-identification signal with a greater energy to be added whilst remaining imperceptible. A speaker identification signal with greater energy can then be more reliably detected. One method of finding the spectral shape of the audio signal is to calculate linear prediction coding (LPC) coefficients for the audio signal, the speaker-identification signal can then be spectrally shaped by passing it through a linear prediction filter set up with those LPC coefficients.

In order to allow analysis of the single-channel audio signal to be performed at a later time, in some embodiments, the single-channel audio signal is recorded in a persistent storage medium.

According to a second aspect of the present invention, there is provided a method of processing a single-channel audio signal representing a multiparty conversation to identify the current speaker, said single-channel audio signal having been generated using a method according to the first aspect of the present invention, said method comprising processing said signal to recognise the presence of a speaker-dependent signal based on a predetermined speaker identification signal in said single-channel audio signal.

By processing said single-channel recording to recognise the speaker-identification signal used in generating the speaker-dependent signal in the single-channel audio signal and thereby identify the current speaker, automatic analysis of the conversation is enabled whilst avoiding the need for finding and storing voiceprints of possible participants in the multi-party conversation.

There now follows, by way of example only, a description of one or more embodiments of the invention. This description is given with reference to the accompanying drawings, in which:

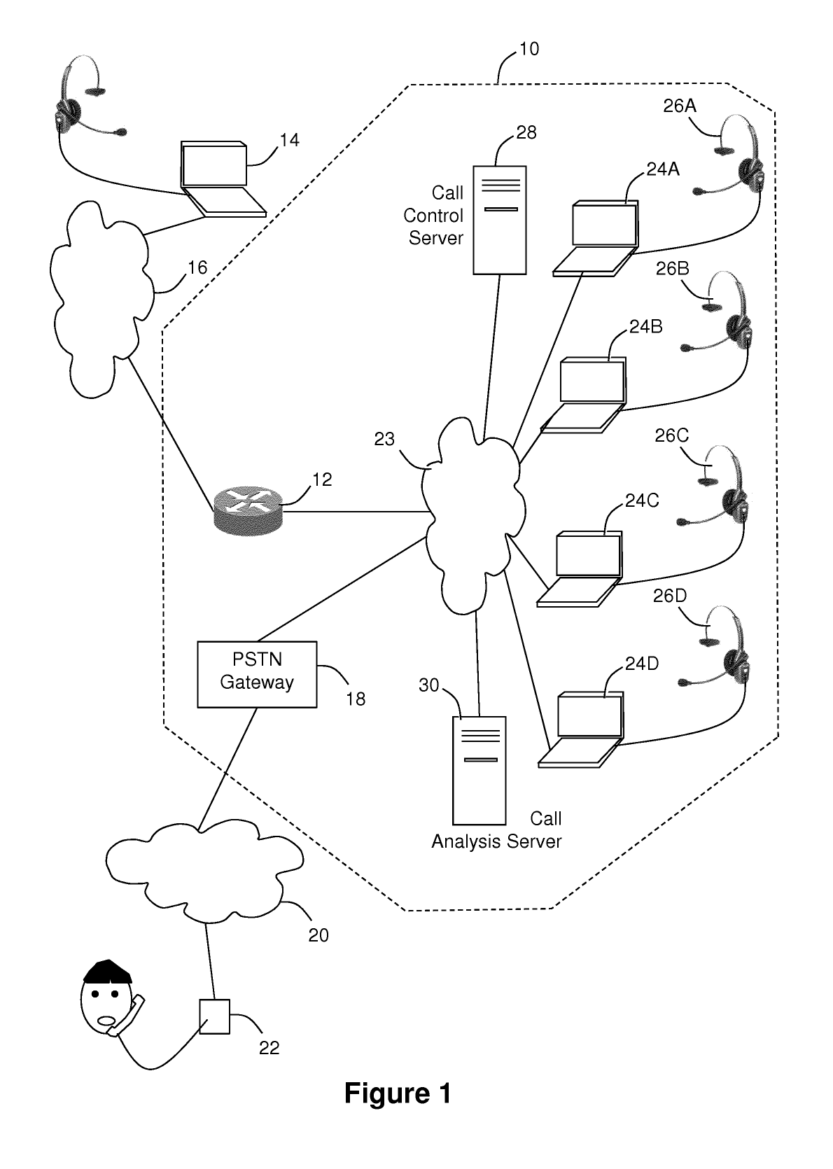

FIG. 1 shows a communications network arranged to provide a contact centre for an enterprise;

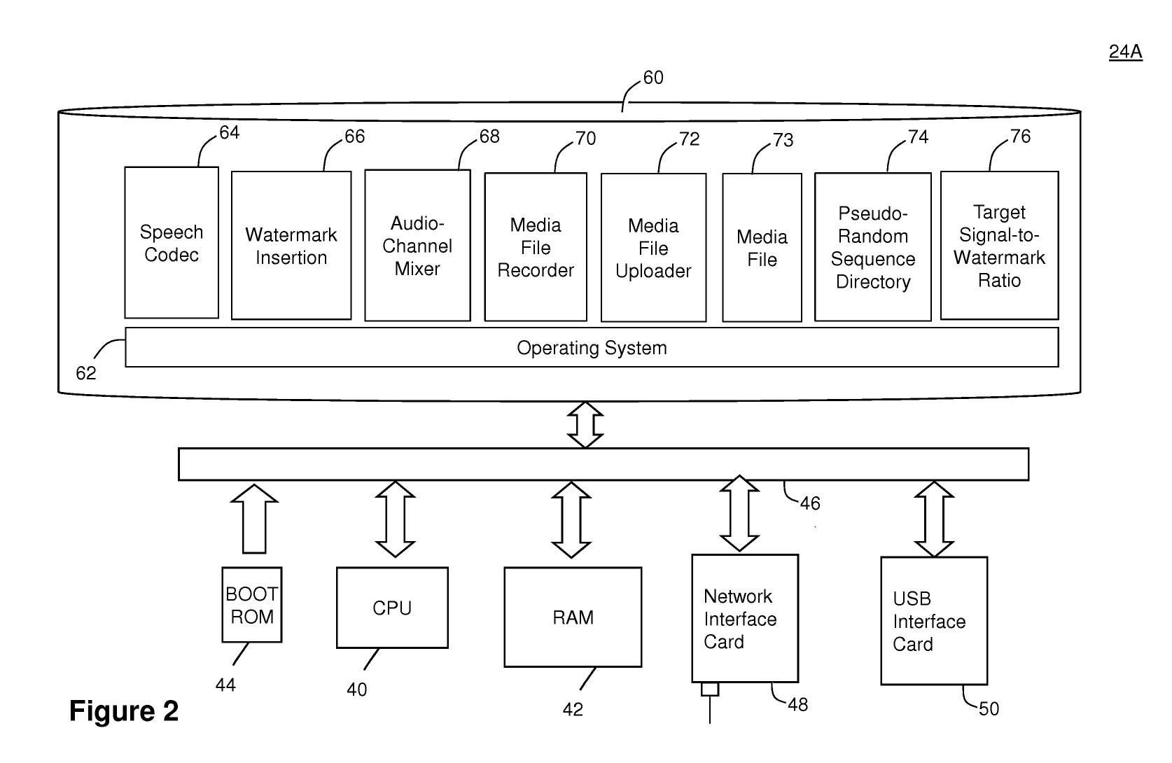

FIG. 2 shows a personal computer used by a customer service agent working in the contact centre;

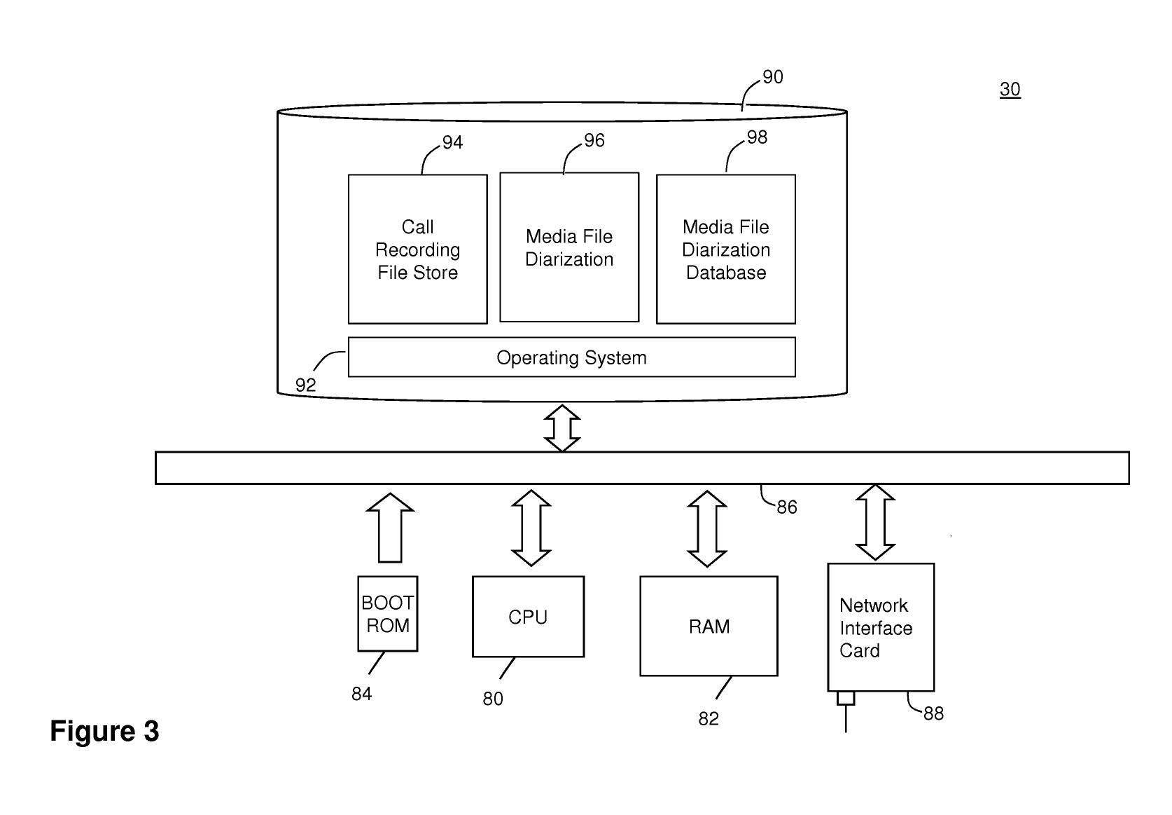

FIG. 3 shows the system architecture of a speech analytics computer connected to the communications network;

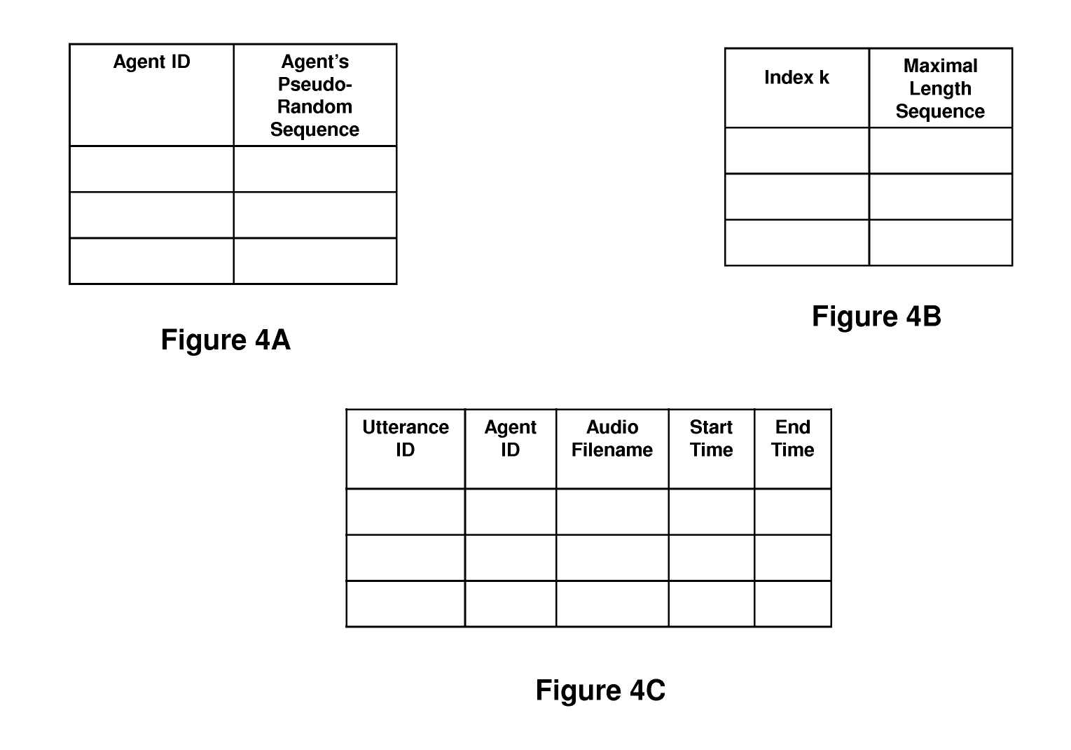

FIGS. 4A-4C illustrate a database stored at the speech analytics computer which stores system configuration data and the speaker diarization results;

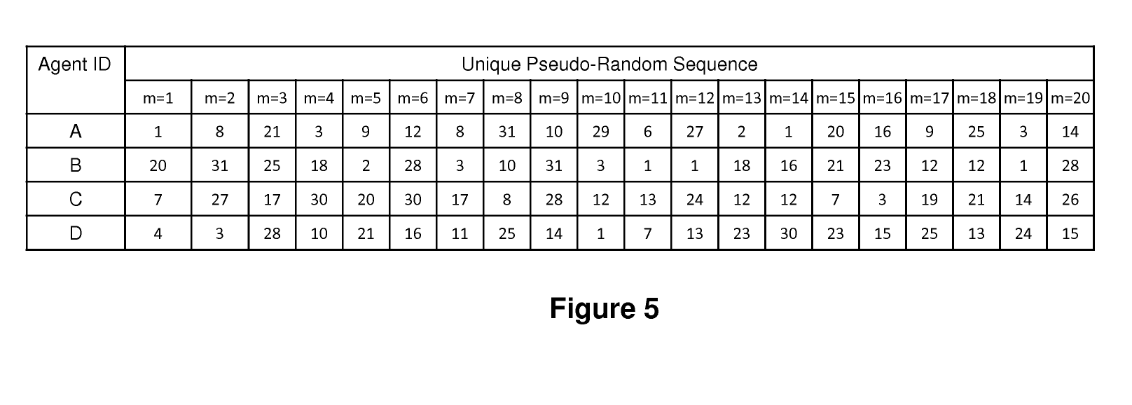

FIG. 5 shows a set of pseudo-random sequences, each pseudo-random sequence being associated with one of the agents in the contact centre;

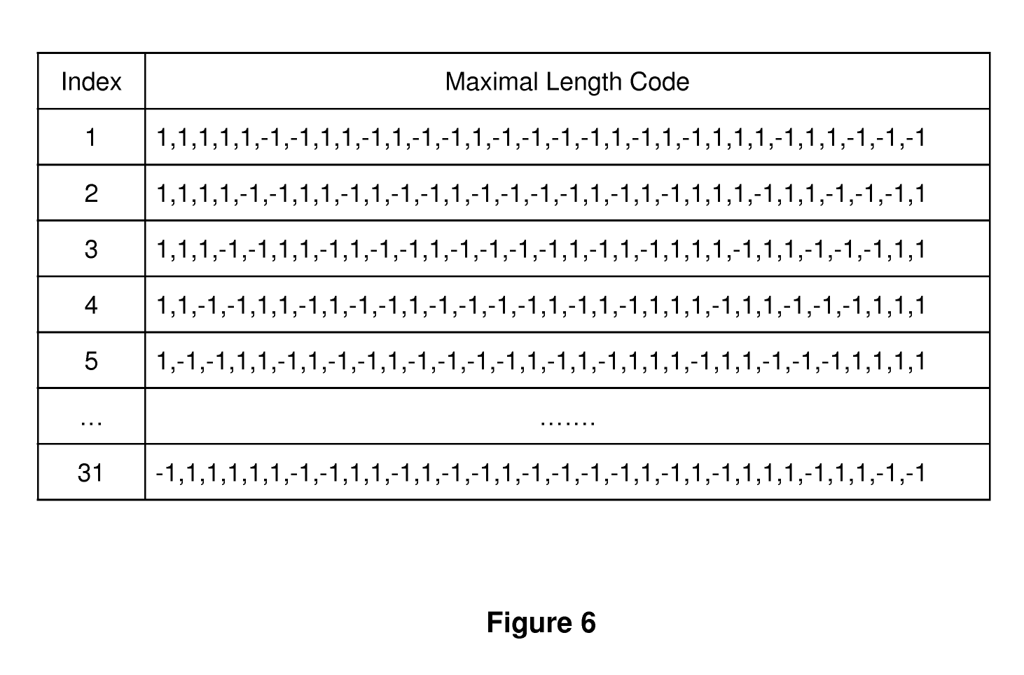

FIG. 6 shows a set of maximal length codes used as the basis of the watermarking signal applied in this embodiment;

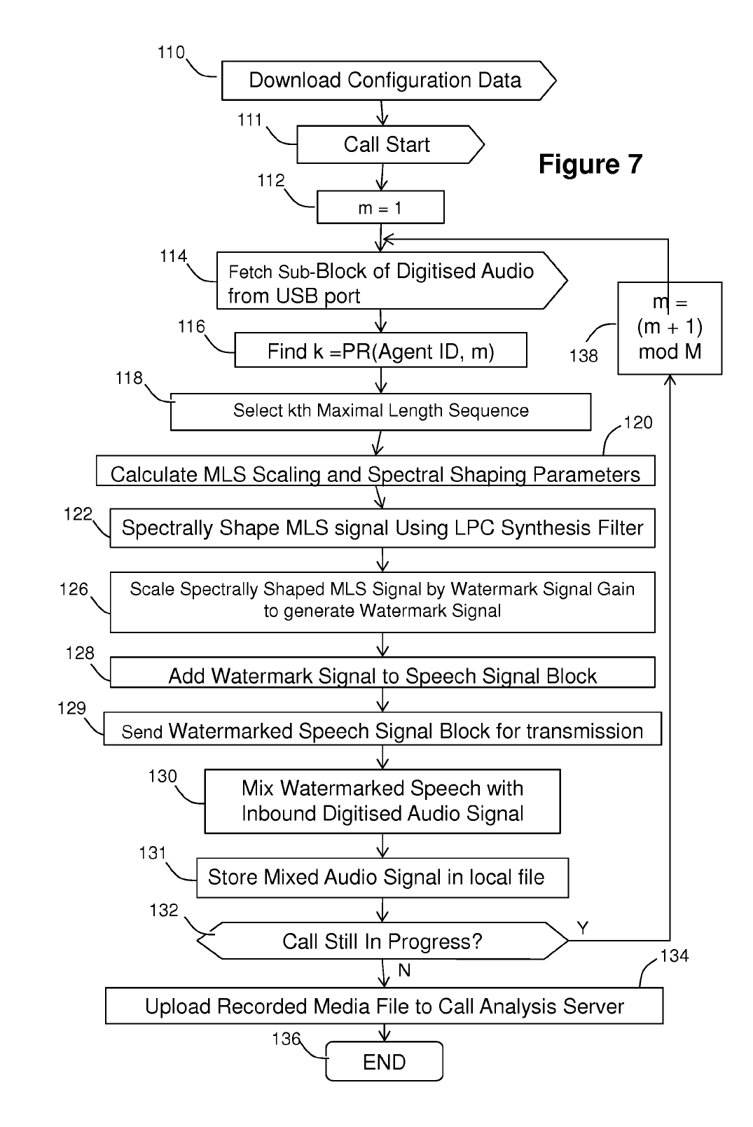

FIG. 7 is a flowchart illustrating the in-call processing of each sub-block of digitised audio representing the audio signal from the agent's microphone;

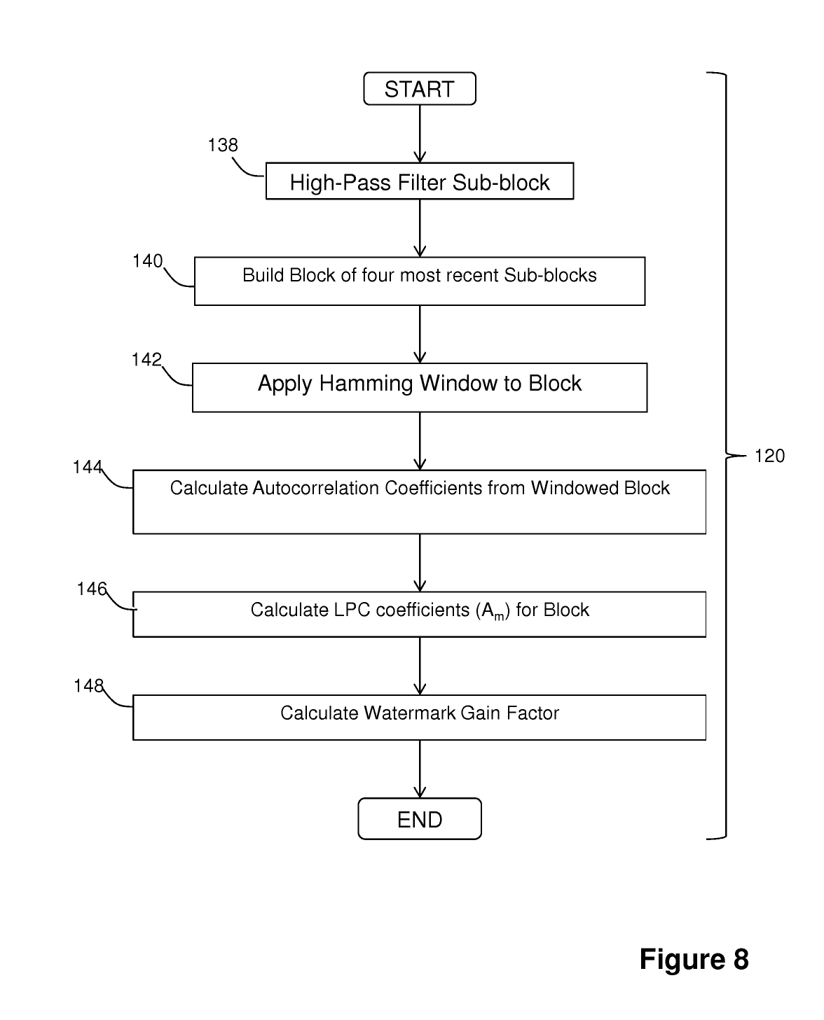

FIG. 8 is a flowchart showing the processing of a block of digitised audio to derive watermark shaping and scaling parameters;

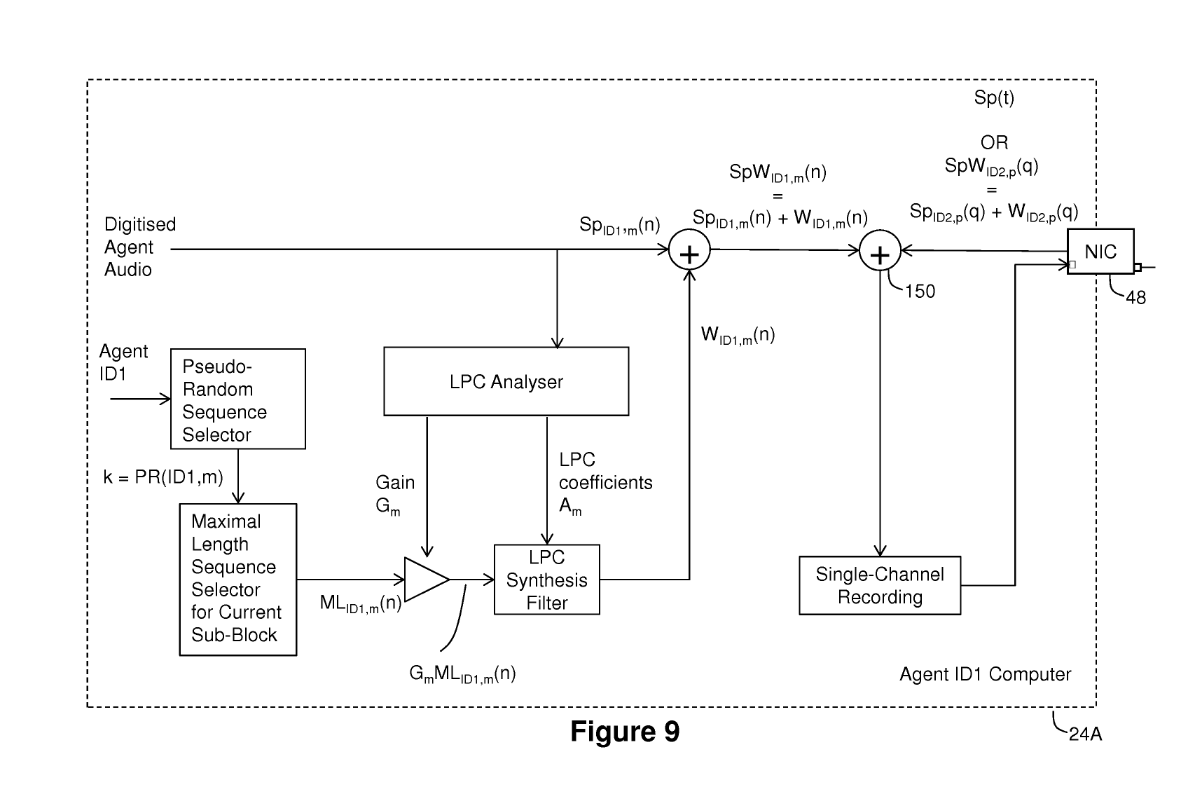

FIG. 9 illustrates the components used in generating the mixed single-channel signal recording the conversation;

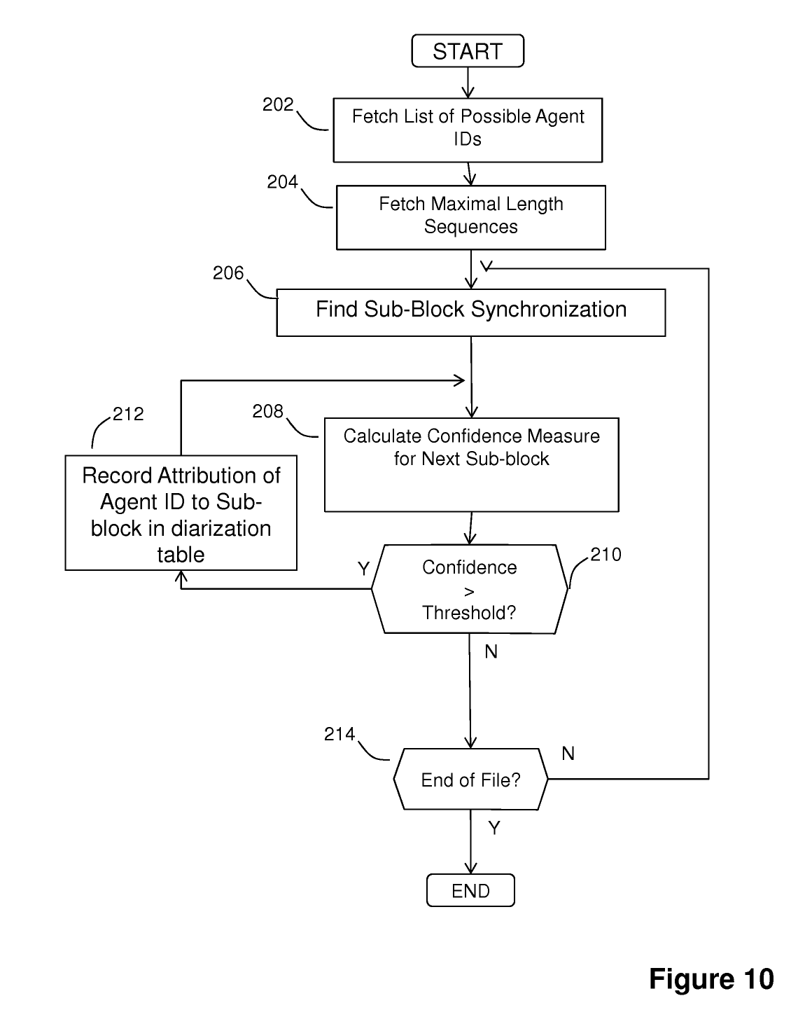

FIG. 10 is a flowchart illustrating a diarization process applied to a single-channel recording of a conversation;

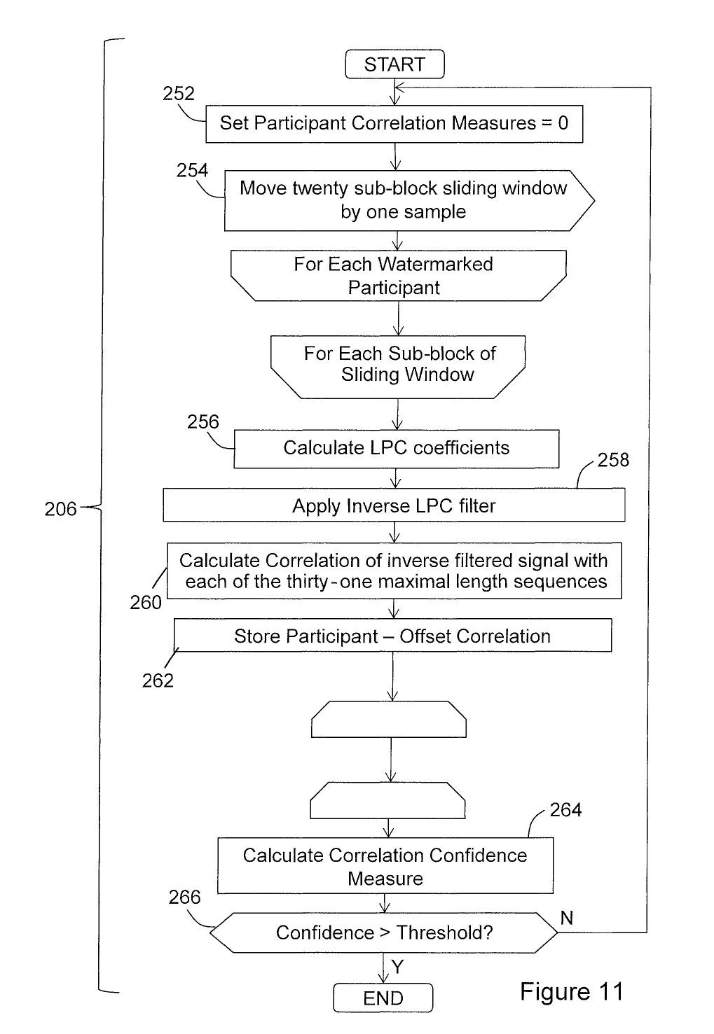

FIG. 11 is a flowchart illustrating a block synchronisation phase of the diarization process;

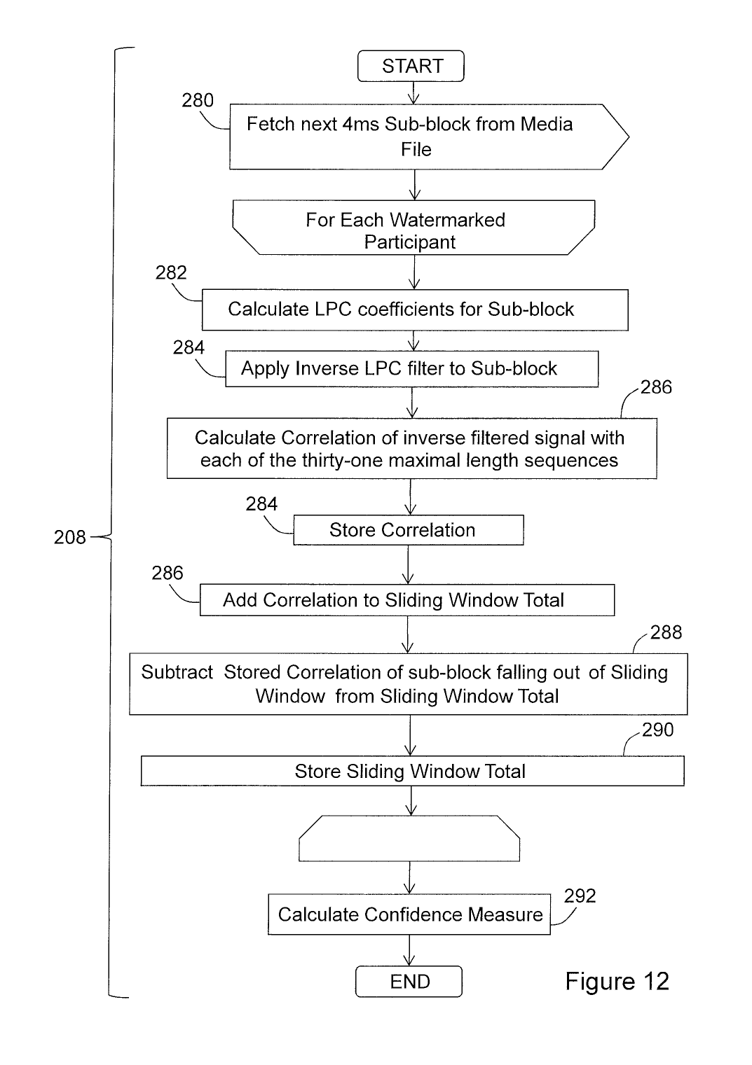

FIG. 12 is a flowchart illustrating a sub-block attribution process included in the diarization process;

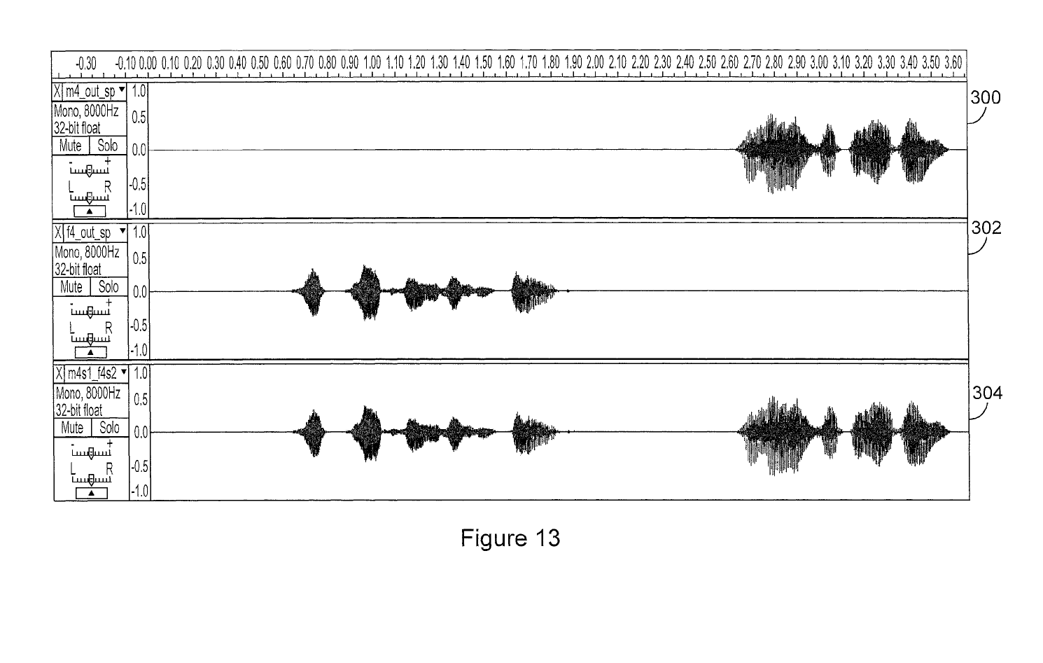

FIG. 13 shows a time-domain audio amplitude plot of a portion of a conversation between a male and female speaker;

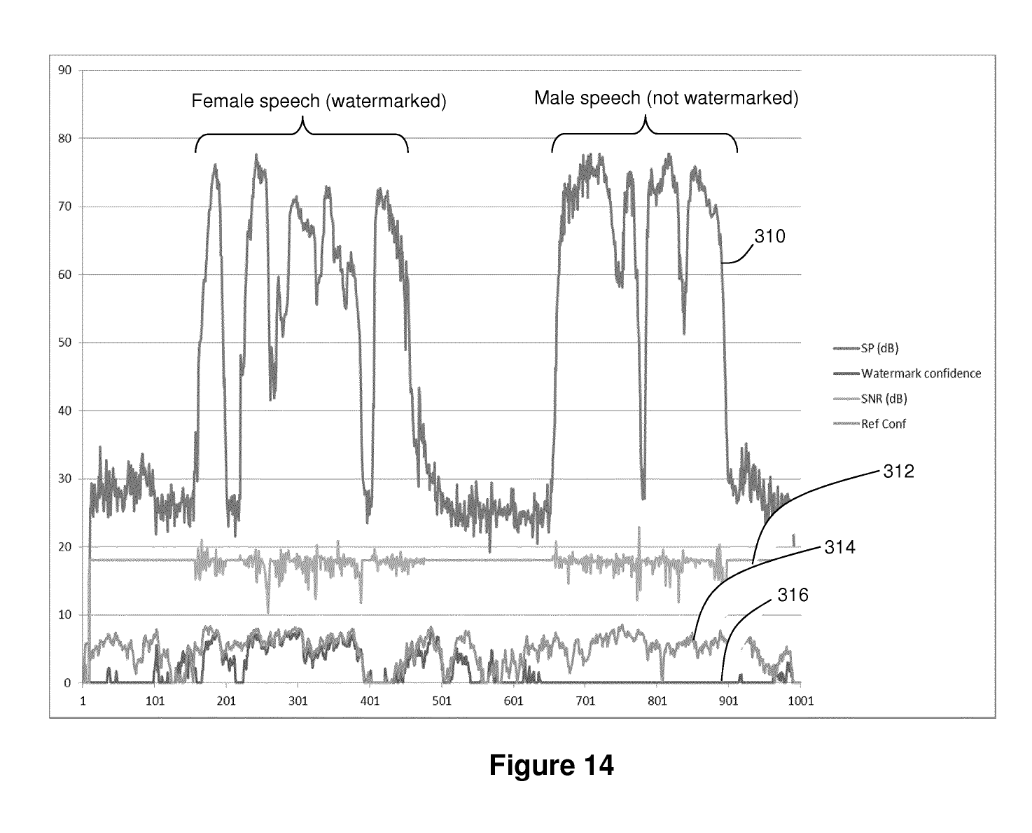

FIG. 14 shows how a watermark detection confidence measure provides a basis for speaker identification;

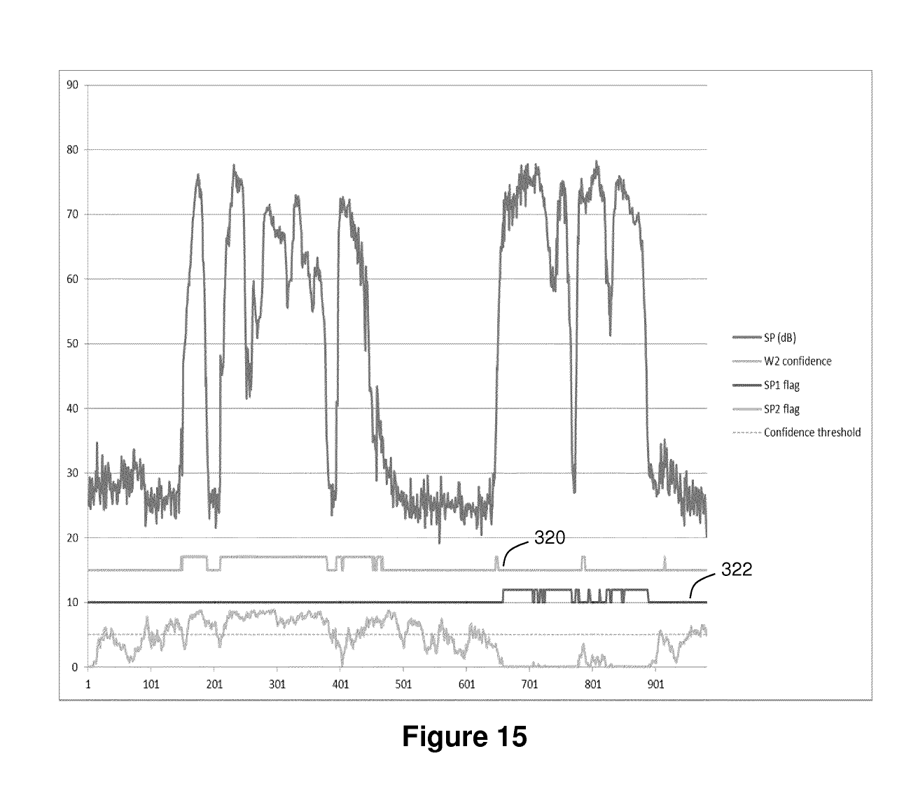

FIG. 15 shows the result of combining voice activity detection flags with watermark recognition thresholds to generate speaker identification flags;

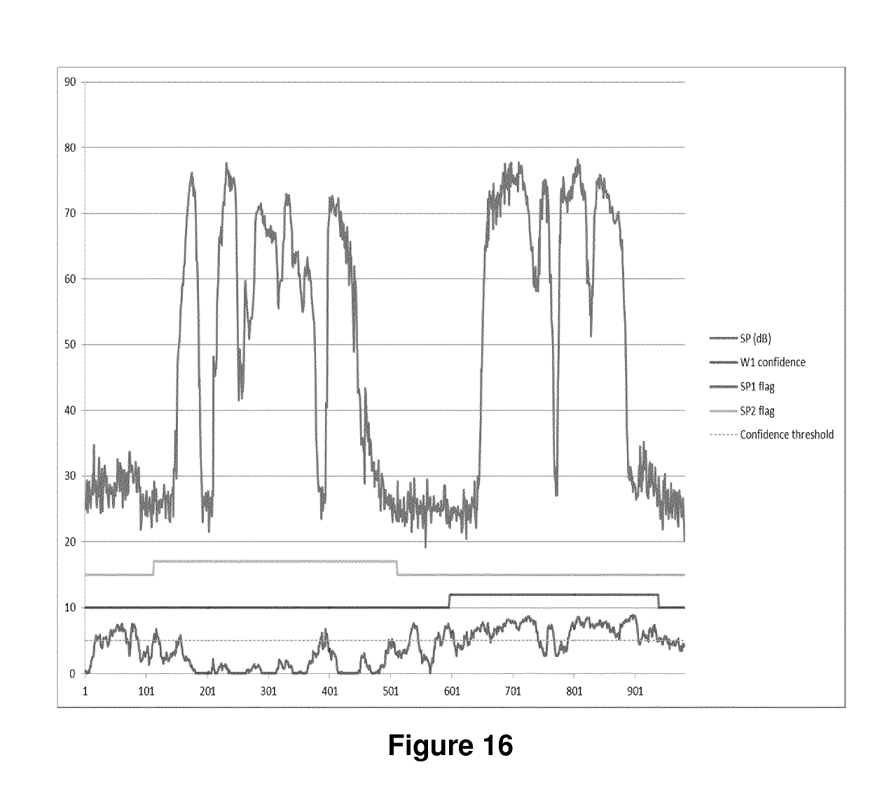

FIG. 16 shows how smoothing of the speaker identification flags over time removes isolated moments of mistaken speaker identification;

In a first embodiment, an IP-based voice communications network is used to deploy and provide a contact centre for an enterprise. FIG. 1 shows an IP-based voice communications network 10 which includes a router 12 enabling connection to VOIP-enabled terminals such as personal computer 14 via an internetwork (e.g. the Internet), and a PSTN gateway 18 which enables connection to conventional telephone apparatus via PSTN 20.

The IP-based voice communications network includes a plurality of customer service agent computers (24A-24D), each of which is provided with a headset (26A-26D). A local area network 23 interconnects the customer service agent computers 24A-24D with a call control server computer 28, a call analysis server 30, the router 12 and the PSTN gateway 18.

Each of the customer service agents' personal computers comprises (FIG. 2) a central processing unit 40, a volatile memory 42, a read-only memory (ROM) 44 containing a boot loader program, and writable persistent memory—in this case in the form of a hard disk 60. The processor 40 is able to communicate with each of these memories via a communications bus 46.

Also communicatively coupled to the central processing unit 40 via the communications bus 46 is a network interface card 48 and a USB interface card 50. The network interface card 48 provides a communications interface between the customer service agent's computer 24A-24D and the local area network 23. The USB interface card 50 provides for communication with the headset 26A-26D used by the customer service agent in order to converse with customers of the enterprise who telephone the call centre (or who are called by a customer service agent—this embodiment can be used in both inbound and outbound contact centres).

The hard disk 60 of each customer service agent computer 24A-24D stores:

i) an operating system program 62,

ii) a speech codec 64,

iii) a watermark insertion module 66;

iv) an audio-channel mixer 68;

v) a media file recorder 70;

vi) a media file uploader 72;

vii) one or more media files 73 storing audio representing conversations involving the agent;

viii) a set of agent names and associated pseudo-random sequences 74; and

ix) a target signal-to-watermark ratio 76.

Some or all of the modules ii) to vi) might be provided by a VOIP telephony client program installed on each agent's laptop computer 24A-24D.

The call analysis server 30 comprises (FIG. 3) a central processing unit 80, a volatile memory 82, a read-only memory (ROM) 84 containing a boot loader program, and writable persistent memory—in this case in the form of a hard disk 90. The processor 80 is able to communicate with each of these memories via a communications bus 86.

Also communicatively coupled to the central processing unit 80 via the communications bus 86 is a network interface card 88 which provides a communications interface between the call analysis server 30 and the local area network 23.

The hard disk 90 of the call analysis server 30 stores:

i) an operating system program 92,

ii) a call recording file store 94,

iii) a media file diarization module 96, and

iv) a media file diarization database 98 populated by the diarization module 96.

One or more of the modules ii) to iv) might be provided as part of a speech analytics software application installed on the call analysis server. The speech analytics software might be run on an application server, and communicate with a browser program on a personal computer via a web server, thereby allowing the remote analysis of the data stored at the call analysis server.

In order to allow subsequent processing to identify watermarked digital audio as representing the voice of a given agent, the media file diarization database (FIG. 3, 98) comprises a number of tables illustrated in FIGS. 4A to 4C. These include:

i) an agent table (FIG. 4A) which records for each agent ID registered with the contact centre one of thirty-one unique pseudo-random sequences, each of which comprises twenty numbers in the range one to thirty-one. Four entries in that table are shown by way of example in FIG. 5. In the present example, the thirty-one pseudo-random sequences are chosen such that each of the thirty-one pseudo-random sequences offers a maximal decoding distance from the others by not sharing any value with the same position in another of the sequences. In other embodiments, longer pseudo-random sequences might be used to provide a greater number of pseudo-random sequences, and thereby enable the system to operate in larger contact centres having a greater number of agents;

ii) an indexed maximal length sequence table (FIG. 4B) which, in this embodiment, lists thirty-one maximal length codes and an associated index for each one. A few entries from the indexed maximal length sequence table are shown in FIG. 6. The maximal length codes are used to provide the basis for the watermark signals used in this embodiment. Each maximal length code can be seen to be equivalent to the code above following a circular shift by one bit to the left. Despite this relationship between the codes, the cross-correlation between any two of the maximal length codes is −1, whereas the autocorrelation of a code with itself is 31.

iii) a diarization table which is populated by the media file diarization module 96 as it identifies utterances in an audio file, and, where possible, attributes those utterances to a particular person. A row is created in the diarization table for each newly identified utterance, each row given (where found) the Agent ID of the agent who said the utterance, the name of the file in which the utterance was found, and the start time and end time of that utterance (typically given as a position in the named audio file).

On an audio marking process (FIG. 7) being launched, the agent's computer 24A-24D queries the database on the call server computer 30 to obtain a unique pseudo-random sequence corresponding to the Agent ID of the agent logged into the computer (from the agent table (FIG. 4A)). Also downloaded is a copy of the indexed maximal length sequence table (FIG. 4B). On a call being connected between a customer and a customer service agent, a counter m is initialised 112 to one. Thereafter, a set of audio sub-block processing instructions (114 to 132) is carried out. Each iteration of the set of instructions (114 to 132) begins by fetching 114 a sub-block of digitised audio from the USB port (which, it will be remembered, is connected to the headset 26A-26B), then processes (116 to 131) that sub-block of digitised audio, and ends with a test 132 to find whether the call is still in progress. If the call is no longer in progress, then the media file (FIG. 2, 73) recording of the conversation is uploaded 134 to the call analysis server 30, after which the audio marking process ends 136. If the call is still in progress then the counter m is incremented 138 (using modulo arithmetic, so that it repeatedly climbs to a value M−1), and another iteration of the set of audio sub-block processing instructions 114 to 132 is carried out.

It is to be noted that the digitised audio received from the USB port will represent the voice of the customer service agent, and periods of silence or background noise at other times. In contact centre environments, the level of background noise can be quite high, so in the present embodiment, the headset is equipped with noise reduction technology.

In the present embodiment, the digitised audio is a signal generated by sampling the audio signal from the agent's microphone at an 8 kHz sampling rate. Each sample is a 16-bit signed integer.

The processing of each sub-block of digitised audio begins with the determination 116 of an index value k. The index is set to the value of the mth element of the downloaded unique pseudo-random sequence. So, referring to FIG. 5, when, for example, the first sub-block of audio is fetched (i.e. m=1) for agent B, the chosen index value will be twenty.

The kth maximal length code from the downloaded indexed maximal length sequence table is then selected 118. Alternatively the maximal length code could be automatically generated by applying k circular leftwards bit shifts to the first maximal length code.

The change in the maximal length code from sub-block to sub-block is used in the present embodiment to avoid the generation of an unwanted artefact in the watermarked digital audio which would otherwise be introduced owing to the periodicity that would be present in the watermark signal were the same watermark signal to be added to each sub-block.

The sub-block is then processed to calculate 120 scaling and spectral shaping parameters to be applied to the selected maximal length sequence to generate the watermark to be added to the sub-block.

The calculation of the scaling and spectral shaping parameters (FIG. 8) begins by high-pass filtering 138 the thirty one sample sub-block to remove unwanted low-frequency components, such as DC, as these can have undesirable effects on the LPC filter shape; in this embodiment a high-pass filter with a cut-off of 300 Hz is used. The thirty-one filtered samples are then passed to a block-building function 140 that adds the most recent thirty-one samples to the end of a 5-sub-block (155 sample, 19 ms) spectral analysis frame. This block length is chosen to offer sufficient length for stable LPC analysis balanced against LPC accuracy. The buffer update method, with LPC frame centre being offset from the current sub-block, offers a reduced buffering delay at the cost of a marginal decrease in LPC accuracy. The block is then Hamming windowed 142 prior to autocorrelation analysis 144, producing ten autocorrelation coefficients for sample delays 1 to 10. Durbin's recursive algorithm is then used 142 to determine LPC coefficients for a 10^{th} order LPC filter. Bandwidth expansion is then applied to the calculated LPC coefficients to reduce the possibility of implementing an unstable all-pole LPC filter.

Those skilled in the art will understand that the LPC synthesis filter models the filtering provided by the vocal tract of the agent. In other words, the LPC filter models the spectral shape of the agent's voice during the current frame of sub-blocks.

In the present embodiment, the target signal-to-watermark ratio (FIG. 2, 76) is set to 18 dB, but the best value depends on the nature of the LPC analysis used (windowing, weighting, order). In practice, the target signal-to-watermark ratio is set to a value in the range 15 dB to 25 dB. In this embodiment, each of agents' computers is provided with the same target signal-to-watermark ratio.

The target signal-to-watermark ratio (SWR dB) is used, along with LPC filter coefficients A_{ID1,m}, to determine the gain factor required for use in the scaling of the selected maximal length sequence. The required energy in the watermark signal is first calculated using equation 1 below.

$$SWR dB = 10 * log 10 \frac{{\sum }_{n = 1}^{31} {Sp}_{ID 1 , m} ( n ) * {Sp}_{ID 1 , m} ( n )}{{\sum }_{n = 1}^{31} {W}_{ID 1 , m} ( n ) * {W}_{ID 1 , m} ( n )} \qquad ( Equation 1 )$$

The terms ‘m’ and ‘ID1’ in the suffix of the audio sample magnitudes Sp_{ID1,m} and the watermark signal values W_{ID1,m} indicate that the values relate to the mth sub-block of audio signal received from a given agent's (Agent ID1's) headset.

The energy of the signal resulting from passing the maximal length code ML_{ID1,m} through an LPC synthesis filter having coefficients A_{ID1,m} is the calculated, and the watermark gain Gₘ required to scale the energy of the filtered maximal length sequence to the required energy in the watermark signal is found. It will be appreciated that, given the constant ratio between the audio signal energy and the watermark energy, the gain will rise and fall monotonically as the energy in the audio signal sub-block rises and falls.

Returning to FIG. 7, the selected maximal length sequence is then passed through an LPC synthesis filter 122 having the coefficients Aₘ to provide thirty-one values which have a similar spectral shape to the spectral shape of the audio signal from the agent's microphone. This provides a first part of the calculation providing a watermark signal which contains as much power as possible whilst remaining imperceptible when added to the sub-block of digital audio obtained from the agent's headset.

The spectrally shaped maximal length sequence signal is then scaled 126 by the calculated watermark signal gain G_{ID1,m} to generate a watermark signal. The scaling of the signal provides a second part of the calculation providing a watermark signal which contains as much power as possible whilst remaining imperceptible to a listener.

The combination of the scaling and spectral shaping of the maximal length sequence is thus in accordance with Equation 2 below.

W_{ID1,m}(n)=G_{ID1,m}*ML_{ID1,m}(n)ConvA_{ID1,m} (Equation 2)

Where ML_{ID1,m} is the maximal length sequence selected for the mth sub-block (which will in turn depend on the index k for the mth sub-block from this agent), and Conv A_{ID1,m} represents a convolution with an LPC synthesis filter configured with the calculated LPC coefficients A_{ID1,m}.

The thirty-one values in the watermark signal are then added 128 to the respective thirty-one sample values found in the audio sub-block signal. In other words, the watermark signal is added in the time domain to the audio block signal to generate a watermarked audio block signal.

The watermarked signal sub-block is then sent 129 for VOIP transmission to the customer's telephone (possibly by way of a VOIP-to-PSTN gateway).

A local recording of the conversation between the call centre agent and the customer is then produced by first mixing 130 the watermarked signal sub-block with the digitised customer audio signal, and then storing 131 the resulting mixed digital signal in the local media file 73. It is to be noted that the combined effect of the pseudo-random sequence of twenty index values k and the thirty-one bit maximal length sequences is to produce a contiguous series of agent identification frames in the watermarked audio signal, each of which is six hundred and twenty samples long. In practice, the sequence added differs from one identification frame to the next because of the scaling and spectral shaping of the signal.

A functional block diagram of the agent computer 24A-24D is shown in FIG. 9. The watermarked signal ID1 (SpW_{ID1,m}(n)) generated by the agent's computer is digitally mixed with the audio signal received from the customer. In the present example, the digital audio signal Sp(t) received from the customer has not been watermarked, but in other examples the digital audio signal (SpW_{ID2,m}(n)) from the customer could be watermarked using a similar technique to that used on the agent's computer.

With regard to the mixing which takes place at the mixer 160, the digitised customer audio signal will not be synchronized with the digitised agent audio signal. This lack of synchronization will be present at the sampling level (the instants at which the two audio signals are sampled will not necessarily be simultaneous), and, in situations where the customer's audio signal is watermarked, at the sub-block, block and identification frame level. Interpolation can be used to adjust the sample values of the digitised customer audio signal to reflect the likely amplitude of the analog customer audio signal at the sample instants used by the agent's headset. The resulting mixed signal SpC(n) is stored as a single-channel recording in a media file.

Returning once again to FIG. 7, the watermarked digital audio signal from the agent's computer and the digital audio signal from the customer's telephone are then stored 131 in the media file (FIG. 2, 73), and, after completion of the call, uploaded via the network interface card 48 to the call analysis server 30.

The operation of the media file diarization module (FIG. 3, item 96) of the call analysis server 30 will now be described with reference to FIG. 10.

Following the uploading of the single-channel recordings of each conversation from the agents' computers 24A-24D to the call recording file store (FIG. 3, item 94) of the call analysis server 30, an administrator can request the automatic diarization of some or all of the call recordings in the file store 94.

On such a request being made, a list of candidate agent IDs, along with the associated pseudo-random sequences, is read 202 from the agent table (FIG. 4A) and the maximal length sequences are thereafter read 204 from the indexed maximal length sequence table (FIG. 4B).

The digital audio samples from the media file to be diarized are then processed to first obtain 206 sub-block synchronisation. This will be described in more detail below with reference to FIG. 11. Once sub-block synchronisation has been achieved, a watermark detection confidence measure is calculated 208 for each sub-block in turn until a test 210 finds the confidence measure has fallen below a threshold. The calculation of the watermark detection confidence measure will be described in more detail below with reference to FIG. 12. For each sub-block for which the test 210 finds that the confidence measure exceeds the threshold, the identified agent ID is attributed to the sub-block with the attribution being recorded 212 in the diarization table (FIG. 4C). When the test 210 finds that the confidence measure has fallen below the threshold, then a test 214 is made to see if the end of the file has been reached. If not, the diarization process returns to seeking sub-block synchronization 206. If the end of the file has been reached, then the process ends.

The sub-block synchronization search (FIG. 11) begins by setting 252 (to zero) a participant correlation measure for each of the possible participants whose speech has been watermarked.

Then, a sliding window correlation analysis 256-266 is carried out, with the sliding window having a length of twenty blocks and being slid one sample at a time.

For each of the possible watermarked participants, a correlation measure is then calculated (256-262).

Each correlation measure calculation (256-262) begins with finding 256 the LPC coefficients for the first thirty-one samples of the sliding window. Those thirty one samples are then passed through the inverse LPC filter 258 which, when the sliding window happens to be in synchrony with the sub-block boundaries used in the watermarking process, will remove the spectral shaping applied to the watermark in the encoding process of the speech of the participant (FIG. 7, 122). It will be appreciated that, even when in synchrony, the LPC coefficients found for the single-channel recording sub-block might not match exactly those found for the input speech sub-block when recording the signal, but they will be similar enough for the removal of the spectral shaping to be largely effective. Thus, the inverse LPC filtering will leave a signal which combines:
SpResₘ(n)—the LPC residual signal for the original speech signal. If the decoder LPC coefficients match those in the encoder, then SpResₘ(n) is a spectrally whitened version of the input speech;
N2ₘ(n)—a linear predicted version of all additional noise signals; and
GₘMLₘ(n)+N3ₘ(n)—a combination of the gain adapted maximal length sequence signal (not spectrally shaped) that was inserted by the encoder with an error signal N3ₘ(n) caused by any mismatch in the encoder and decoder LPC coefficients.

The correlation between the inverse filtered sub-block and each of the thirty-one maximal length sequences is then found 260 using Equation (3) below.

$${Wcorr}_{m} ( k ) = \frac{( \frac{1}{31} ) * {\sum }_{n = 1}^{31} ML 31 ( k , n ) * ( {SpCRes}_{m} ( n ) )}{sqrt ⌊ ( \frac{1}{31} ) * {\sum }_{n = 1}^{31} sqr ( {SpCRes}_{m} ( n ) ) ⌋} \qquad Equation ( 3 )$$

Where k is the maximal length sequence index (working on the hypothesis that the 620 sample identification frame is aligned with the sliding window), ML31(k,n) represents the nth bit of the kth maximal length sequence and SpCResₘ(n) represents the residual signal resulting from passing the recorded single channel audio signal SpC(n) through the inverse LPC filter.

Because of the working hypothesis that the 620 sample identification frame is aligned with the sliding window, the hypothetical index k of the maximal length sequence for the current sub-block m will be known. To give an example, if this is the first sub-block in the sliding window, and the current outer loop is calculating a correlation measure for Agent ID A, then the index k is one (see FIG. 5), and the relevant maximal length sequence for the purpose of working out the sub-block correlation score is that seen in the first row of FIG. 6.

The sub-block correlation measures found in this way are then added to the cumulative correlation measure for the participant currently being considered—with the maximal length sequence selected according to the pseudo-random sequence associated with that participant. The cumulative correlation measure is calculated according to Equation 4 below:

$$WCorrAv ( i ) = {\sum }_{m = 1}^{20} {WCorr}_{m} ( {k}_{m} ) i = 1. .31 \qquad Equation ( 4 )$$

Where the parameter kₘ represents the index k for the mth element of the pseudo-random sequence associated with the participant.

Once the cumulative correlation over the twenty sub-blocks for the current participant has been found, the cumulative correlation measure for the current participant is stored 264, and the process is repeated for any remaining possible watermarked participants. Once a cumulative correlation measure has been found for each of the possible participants, a synchronization confidence measure is calculated 264 in accordance with Equation 5 below.

$$Conf ( m ) = \frac{( Max 1 - Max 2 )}{Max 1} \qquad Equation ( 5 )$$

where Max1 is the highest cumulative correlation measure found, and Max2 is the second highest cumulative correlation measure found. On a confidence test 266 finding that Conf(m) is less than or equal to a threshold value, the identification frame synchronisation process is repeated with the sliding window moved on by one sample. On the test 266 finding that Conf(m) exceeds a threshold, identification frame synchronisation (and hence sub-block synchronisation) has been found, and the diarization process moves on to calculating (FIG. 10, 208) a confidence measure for the next sub-block in the recorded signal. That process will now be described with reference to FIG. 12.

The sub-block watermark detection confidence calculation begins by fetching the next thirty one samples from the media file. A sliding window correlation calculation (282-290) is then carried out for each possible participant in the conversation.

The sliding window correlation calculation begins with the calculation 282 of the LPC coefficients for the sub-block, and an analysis filter with those coefficients is then used to remove 284 the spectral shaping applied to the watermark in the watermarking process. The correlation of the filtered samples with each of the thirty-one maximal length sequences is then calculated 286 (using equation (3) above) and stored 284. The calculated correlation is added 286 to a sliding window total for the participant, whilst any correlation calculated for the participant for the sub-block immediately preceding the beginning of the sliding window is subtracted 288. The sliding window total for the participant is then stored 290.

Once the sub-block correlation calculation for a given sliding window position is complete, a confidence measure is calculated 292 in accordance with equation 5 above (though in some embodiments, a different threshold is used). As explained above in relation to FIG. 10, when the threshold is exceeded, an association between the sub-block and the participant for whom the correlation was markedly higher than the others is found. The association for the sub-blocks are then combined with a voice activity detection result, and sliding-window median smoothing and pre and post hangover is applied to attribute certain time portions of the conversation to a participant. That attribution is then recorded in the diarization table (FIG. 4C).

The effect of the above embodiment will now be illustrated with reference to FIGS. 13 to 16.

The inventors have found that when a speech signal with a watermark is mixed with a speech signal without a watermark, then the watermark detection confidence is affected by the relative energies of the signals being mixed. A 4 s male signal (FIG. 13, 300) and a 4 s female signal with an −18 dB watermark signal embedded within it (FIG. 13, 302) were mixed to give a 4 s mixed signal (FIG. 13, 304) where the male and female active speech regions are non-overlapping. The combined signal was passed through the correlation process (FIG. 10), and results are shown in FIG. 14. In FIG. 14, the decoded signal energy 310 shows the active region of the watermarked female speech in blocks 150 to 450, and active male speech in block 650 to 900. The signal-to-watermark ratio 312 can be seen to vary around the target signal-to-watermark ratio (18 dB in this embodiment) during periods of speech. The confidence of detecting the watermark from the female speech without mixing 314 shows strong confidence through most of the signal for active and inactive female speech regions. The confidence 316 of detecting the watermark from the female speech in the mixed signal is low for all regions, except for the active female speech region. The results show that for this region (blocks 150 to 450) the confidence level is broadly comparable with the confidence for the unmixed female signal.

In order to derive binary signals (flags) which indicate who was speaking when, the following Boolean equations were used, where the SP1 flag indicates the presence of male active speech and the SP2 flag indicates the presence of female active speech:

SP1 flag: (Female watermark confidence<T2) AND (speech activity=TRUE)

SP2 flag: (Female watermark confidence>T1) AND (speech activity=TRUE)

The results are shown in FIG. 14. It can be seen that the SP1 flag 320 and SP2 flag 322 correctly identify the current speaker, save for some momentary errors.

Applying a combination of sliding-window median smoothing and pre and post hangover removes these momentary errors are can be seen in FIG. 16.

As can be seen from FIGS. 13 to 16, for single watermark signals, the property that the confidence of detection of a watermark in background noise is severely degraded by the presence of other audio signals can be used to separate the mixed signals. If the audio signals for both participants were watermarked using unique basic identification sequences, then the pair of decisions would be modified to:

SP1: (Male confidence>T1) AND (speech activity=TRUE)

SP2: (Female watermark confidence>T1) AND (speech activity=TRUE)

These decision values still rely on the degradation of detection confidence for the watermarks in background noise mixed with the other active speech signals. Without this property, it would not be possible to identify which watermark was present in each segment of active speech, without recourse to some form of voice-activated watermark insertion in the encoder.

Possible variations on the above embodiments include (this list is by no means exhaustive):

i) whilst in the above embodiments, the contact centre was provided using an IP-based voice communications network, in other embodiments other technologies such as those used in Public Switched Telephony Networks, ATM networks or an Integrated Service Digital Networks might be used instead;

ii) in other embodiments, the above techniques are used in conferencing products which rely on a mixed audio signal, and yet provide spatialized audio (so different participants sound as though they are in different positions relative to the speaker);

iii) in the above embodiments, a call recording computer was provided. In other embodiments, legacy call logging apparatus might provide the call recording instead. Because the watermark is added by the terminals in the system, the benefits of the above embodiment would still be achieved even in embodiments where legacy call logging apparatus is used in the contact centre;

iv) in the above embodiments, the media files recording the interactions between the customer service agents and customers were stored at the call analysis server. In other embodiments, the media file recording the interactions between the customer service agents and customers could be uploaded to and stored on a separate server, being transferred to the call analysis server temporarily in order to allow the call recording to be analysed and the results of that analysis to be stored at the call analysis server.

v) in the above embodiments, the watermark signal was given an energy which was proportional to the energy of the signal being watermarked. In other embodiments, the calculated LPC coefficients could be used to generate an LPC analysis filter and the energy in the residual obtained on applying that filter to the block could additionally be taken into account. In yet other embodiments, the watermark signal could be given an energy floor even in situations where very low energy is present in the signal being watermarked.

vi) in the above embodiments, the LPC coefficients were calculated for blocks containing 155 digital samples of the audio signal. Different block sizes could be used, provided that the block sizes are sufficiently short to mean that the spectrum of the speech signal is largely stationary for the duration of the block.

vii) in the above embodiments, the watermark was added to the audio being transmitted over the communications network to the customer. In other embodiments, the watermark might only be added to the recorded audio, and not added to a separate audio stream sent to the customer. This could alleviate any problems caused by delay being added to the transmission of the agent's voice to the customer.

viii) in other embodiments, the customer might additionally have a terminal which adds a watermark to the audio produced by their terminal. In yet other embodiments, the customer's terminal might add a watermark to the customer's audio and the customer service agent's terminal might not add a watermark to the agent's audio.

ix) in the above embodiments, each agent had a unique ID and could be separately identified from a recording. In other embodiments, all agents could be associated with the same watermark, or groups of agents could be associated with a common watermark.

x) in some embodiments, the mixed digitised audio signal could be converted to an analogue signal before recording, with the subsequent analysis of the recording involved converting the recorded analogue signal to a digital signal.

xi) in the above embodiments, the single-channel mixed signal was generated by summing the magnitudes of the digitised audio signal in the time domain. In alternative embodiments, the summation of the two signals might be done in the frequency domain or any other digital signal processing technique which has a similar effect might be used.

xii) in the above embodiments, digital audio technology was used. However, in other embodiments, analog electronics might be used to generate and add analog signals corresponding to the digital signals described above.

xiii) the above embodiments relate to the recording and subsequent analysis of a voice conversation. In other embodiments, one or more of the participants has a terminal which is also generates a video signal including an audio track—the audio track then being modified in the way described above in the recorded video signal.

xiv) in the above embodiments, linear predictive coding techniques were used to establish the current spectral shape of the customer service agent's voice, and process the watermark to give it the same spectral shape before generating a single-channel audio signal by adding the watermark, the signal representing the customer service agent's voice, and the signal representing the audio from the customer (usually background noise when the customer service agent is speaking). In other embodiments, the linear predictive coding is avoided in the generation of the single-channel audio signal, so that the watermark is not spectrally shaped to match the voice signal. In some such embodiments, linear predictive coding can also be avoided in the analysis of the single-channel audio signal. The downside of avoiding the use of linear predictive coding is that the energy in the watermark signal is that much lower relative to the energy in the single-channel audio signal, making the recovery of the watermark signal more challenging.

xv) in embodiments where a voice activity detector (VAD) is used, then the watermark can be applied only to the current speaker. If this were done centrally (for example at a conferencing bridge or media server), then the amount of processing required, and hence the cost of the system, would be reduced.

xvi) in the above embodiments, the audio signal from the agent's microphone was sampled at an 8 kHz sampling rate. In other embodiments, a higher sampling rate might be used (for example, one of the sampling rates (44.1, 48, 96, and 192 kHz) offered by USB audio). In the above embodiment, the sample size was is 16 bits. In other embodiments, higher sample sizes, for example 16 or 32 bits might be used instead. For higher sampling rates, the LPC shaping would be of even greater benefit as lack of high frequency energy in speech would provide little masking for white-noise-like watermark signals.

xvii) in the first of the above embodiments, synchronization was achieved by performing a sliding window correlation analysis between the recorded digitised audio signal and each of the basic agent identification sequences. In other embodiments, the digital audio recording might include framing information which renders the synchronization process unnecessary.

xviii) in other embodiments, in the synchronization process, an additional timing-refinement step may be required to account for any possible sub-sample shifts in timing that may have occurred in any mixing and re-sampling processes carried out after the watermark has been applied; such a step would involve interpolation of either the analysis audio signal or the target watermark signals.

xix) in the above embodiments, there are 31 different ML codes, which form the basis of the watermark signalling. Each of the indices in the PR sequences reference an ML code; the PR sequences allow averaging over time (multiple ML codes) to be performed without the introduction of audible buzzy artifacts from repetitive ML codes. In embodiments where the artifact problem is ignored, then each ID could be assigned just one of the 31 ML codes and the averaging length would be set according to desired robustness. FIG. 5 would then be rows of same index, which would still be maximal distance. To get more than 31 ID codes (for our ML31 base codes), then more rows would be added to FIG. 5 by repeating indices within columns, and therefore making the codes non-maximal-distance; the decrease in robustness could be countered by a longer averaging length.

In summary of the above disclosure, an enterprise voice system such as a contact centre is disclosed which provides a speech analytics capability. Whilst call recording is common in many contact centres, calls are normally recorded in single-channel audio files in order to save costs. Previous attempts to provide automatic diarization of those recorded calls have relied on training the system to recognise voiceprints of users of the system, and then comparing utterances within the recorded calls to those voiceprints in order to identify who was speaking at that time. In order to avoid the need to train the system to recognise voiceprints, an enterprise voice system is disclosed which inserts a mark into the audio signal from each user's microphone. By inserting the mark with an energy, and, in some cases also with a spectrum, which matches the audio signal into which it is inserted, and taking advantage of typically only one user speaking at a time, a mark is left in the recorded call which a speech analytics system can use in order to identify who was speaking at different times in the conversation.

1. A method of generating a single-channel audio signal representing a multi-party conversation, said method comprising:
receiving a plurality of audio signals representing the voices of respective participants in the multi-party conversation, and for at least one of the participants, marking the audio signal representing the participant's voice, at least when they are speaking, by:
i) finding the current energy in the audio signal representing the participant's voice;
ii) generating a speaker-dependent signal having an energy proportional to the current energy in the audio signal representing the participant's voice; and
iii) adding said speaker-dependent signal to the audio signal representing the participant's voice to generate a marked audio signal;
generating a single-channel audio signal by summing said at least one marked audio signal and any of said plurality of audio signals which have not been marked.

2. A method according to claim 1 wherein said speaker-dependent signal is generated from a predetermined speaker identification signal.

3. A method according to claim 2 wherein the generation of said speaker-dependent signal comprises scaling said predetermined speaker-identifying signal, or a portion thereof, added over an energy analysis time period by an amount proportional to the energy found in the audio signal representing the participant's voice over said energy analysis time period.

4. A method according to claim 1 where said speaker identification, speaker-dependent and audio signals comprise digital signals.

5. A method according to claim 4 wherein said speaker identification signal comprises a digital watermark.

6. A method according to claim 4 wherein said speaker identification signal comprises a pseudo-random bit sequence.

7. A method according to claim 6 wherein said speaker identification signal comprises a maximal length sequence.

8. A method according to claim 4 further comprising:
finding the spectral shape of said audio signal over a spectral analysis time period,
said speaker-dependent signal generation comprising spectrally shaping said speaker-identification signal, or a portion thereof, to generate a speaker-dependent signal whose spectrum is similar to the spectrum of said audio signal over said spectral analysis time period.

9. A method according to claim 8 wherein:
finding the spectral shape of said audio signal comprises calculating linear prediction coding coefficients for the audio signal; and
spectrally shaping said speaker-identification signal comprises passing the speaker-identification signal through a linear prediction synthesis filter configured with said calculated linear prediction coding coefficients.

10. A method of recording a multi-party conversation comprising generating a single-channel audio signal representing the multi-party conversation using the method of claim 1, and recording said single-channel audio signal.

11. A method of processing an audio signal to identify a current speaker, said audio signal having been generated using the method of claim 1, said method comprising processing said signal to recognise the presence of a speaker-dependent signal in said signal.

12. A method according to claim 11 wherein said processing comprises:
passing said single-channel audio signal through a linear prediction analysis filter to remove predictable elements of said single-channel audio signal; and
carrying out a correlation analysis looking for correlations with said one or more speaker-dependent signals in order to recognise the presence of a given speaker-dependent signal in said single-channel audio signal.
